(19) United States
(12) Patent Application Publication
(10) Pub. No.: US 2025/0267098 A1
(43) Pub. Date: Aug. 21, 2025

(54) SYSTEMS AND METHODS OF INDICATING CONGESTION SEVERITY

(71) Applicant: Meta Platforms Technologies, LLC, Menlo Park, CA (US)

(72) Inventors: Liwen Yu, Santa Clara, CA (US); Qi Qu, Redmond, WA (US); Ping Wang, Redmond, WA (US); Xiaodi Zhang, San Ramon, CA (US)

(73) Assignee: Meta Platforms Technologies, LLC, Menlo Park, CA (US)

(21) Appl. No.: 19/031,229

(22) Filed: Jan. 17, 2025

Related U.S. Application Data
(60) Provisional application No. 63/554,201, filed on Feb. 16, 2024.

(51) Int. Cl. H04L 47/11; H04L 47/12

(52) U.S. Cl. CPC H04L 47/11; H04L 47/12

(57) ABSTRACT

Systems and methods of indicating congestion severity may include a wireless communication endpoint that receives, via a transceiver from a base station, one or more first packets. The one or more first packets may include one or more bits configured by the base station based according to a network congestion level. The wireless communication endpoint may determine the network congestion level from a plurality of network congestion levels. The network congestion level may be based on the one or more bits configured by the base station in the one or more packets. The wireless communication endpoint may selectively update one or more configurations for generating one or more second packets for transmission to the base station. The one or more configurations may be selectively updated according to the network congestion level.

### CROSS-REFERENCE TO RELATED PATENT APPLICATIONS

The present application claims the benefit of and priority to U.S. Provisional Application No. 63/554,201, filed Feb. 16, 2024, the disclosure of which is incorporated herein by reference in its entirety.

### FIELD OF DISCLOSURE

The present disclosure is generally related to wireless communication, including but not limited to, systems and methods of indicating congestion severity.

### BACKGROUND

Augmented reality (AR), virtual reality (VR), and mixed reality (MR) are becoming more prevalent, with such technology being supported across a wider variety of platforms and devices. Some AR/VR/MR devices may communicate with one or more other remote devices via a cellular connection.

### SUMMARY OF THE INVENTION

In one aspect, this disclosure is directed to a method. The method may include receiving, by a wireless communication endpoint from a base station, one or more first packets. The one or more first packets may include one or more bits configured by the base station based according to a network congestion level. The method may include determining, by the wireless communication endpoint, the network congestion level from a plurality of network congestion levels. The network congestion level may be based on the one or more bits configured by the base station in the one or more packets. The method may include selectively updating, by the wireless communication endpoint, one or more configurations for generating one or more second packets for transmission to the base station. The one or more configurations may be selectively updated according to the network congestion level.

In some embodiments, the one or more configurations include a bitrate, and the method may include determining, by the wireless communication endpoint, to update the bitrate for generating the one or more second packets, based on the network congestion level. The method may include generating, via a codec of the wireless communication endpoint, the one or more second packets using the updated bitrate. In some embodiments, the method includes transmitting, by the wireless communication endpoint to the base station, the one or more second packets generated using the updated bitrate. In some embodiments, the one or more configurations include at least one of a bitrate, a resolution, or a frame rate.

In some embodiments, the one or more first packets include a plurality of first packets, each packet of the plurality of first packets having a field corresponding to an explicit congestion notification signal from the base station. In some embodiments, the wireless communication endpoint determines the network congestion level based on a first count of first values of the field, for a portion of the plurality of first packets, relative to a second count of second values of the field, for another portion of the plurality of first packets. In some embodiments, the wireless communication endpoint determines the network congestion level based on a pattern of values indicated in the field corresponding to the explicit congestion notification signal.

In some embodiments, the one or more first packets include a header having two or more bits, where a value of the two or more bits corresponds to a respective network congestion level. In some embodiments, the header has at least three bits corresponding to the respective network level, and a respective value of the at least three bit is configurable by the base station to indicate a corresponding network congestion level from eight different network congestion levels. In some embodiments, the two or more bits are included in a packet data convergence protocol (PDCP) layer header. In some embodiments, the wireless communication endpoint includes at least one of an application server or user equipment.

In another aspect, this disclosure is directed to a wireless communication endpoint. The wireless communication endpoint may include a transceiver. The wireless communication endpoint may include one or more processors configured to receive, via the transceiver from a base station, one or more first packets. The one or more first packets may include one or more bits configured by the base station based according to a network congestion level. The one or more processors may be configured to determine the network congestion level from a plurality of network congestion levels. The network congestion level may be based on the one or more bits configured by the base station in the one or more packets. The one or more processors may be configured to selectively update one or more configurations for generating one or more second packets for transmission to the base station. The one or more configurations may be selectively updated according to the network congestion level.

In some embodiments, the one or more configurations include a bitrate and the one or more processors may be configured to determine to update the bitrate for generating the one or more second packets, based on the network congestion level. The one or more processors may be configured to generate, via a codec, the one or more second packets using the updated bitrate. The one or more processors may be configured to transmit, via the transceiver, the one or more second packets to the base station. In some embodiments, the one or more configurations include at least one of a bitrate, a resolution, or a frame rate.

In some embodiments, the one or more first packets include a plurality of first packets, each packet of the plurality of first packets having a field corresponding to an explicit congestion notification signal from the base station. In some embodiments, the one or more processors are configured to determine the network congestion level based on a pattern of values indicated in the field corresponding to the explicit congestion notification signal.

In some embodiments, the one or more first packets include a header having two or more bits, where a value of the two or more bits corresponds to a respective network congestion level. In some embodiments, the header has at least three bits corresponding to the respective network level, and a respective value of the at least three bit is configurable by the base station to indicate a corresponding network congestion level from eight different network congestion levels. In some embodiments, the wireless communication endpoint includes at least one of an application server or user equipment.

In yet another aspect, this disclosure is directed to a non-transitory computer readable medium storing instructions that, when executed by one or more processors, cause the one or more processors to receive, from a base station, one or more first packets. The one or more first packets may include one or more bits configured by the base station based according to a network congestion level. The instructions may cause the one or more processors to determine the network congestion level from a plurality of network congestion levels. The network congestion level may be based on the one or more bits configured by the base station in the one or more packets. The instructions may cause the one or more processors to selectively update one or more configurations for generating one or more second packets for transmission to the base station. The one or more configurations may be selectively updated according to the network congestion level.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment, according to an example implementation of the present disclosure.

FIG. 5 is a block diagram of a system for explicit congestion signaling, according to an example implementation of the present disclosure.

FIG. 6 is a block diagram of a system for explicit congestion signaling, according to another example implementation of the present disclosure.

FIG. 7 is a block diagram of a packet including a field for providing an explicit congestion notification, according to an example implementation of the present disclosure.

FIG. 8 is a display of congestion patterns with bitrate adjustment, according to an example implementation of the present disclosure.

FIG. 9 is a display of a packet data convergence protocol (PDCP) frame used for congestion signaling, according to an example implementation of the present disclosure.

FIG. 10 is a flowchart showing an example method for explicit congestion signaling, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

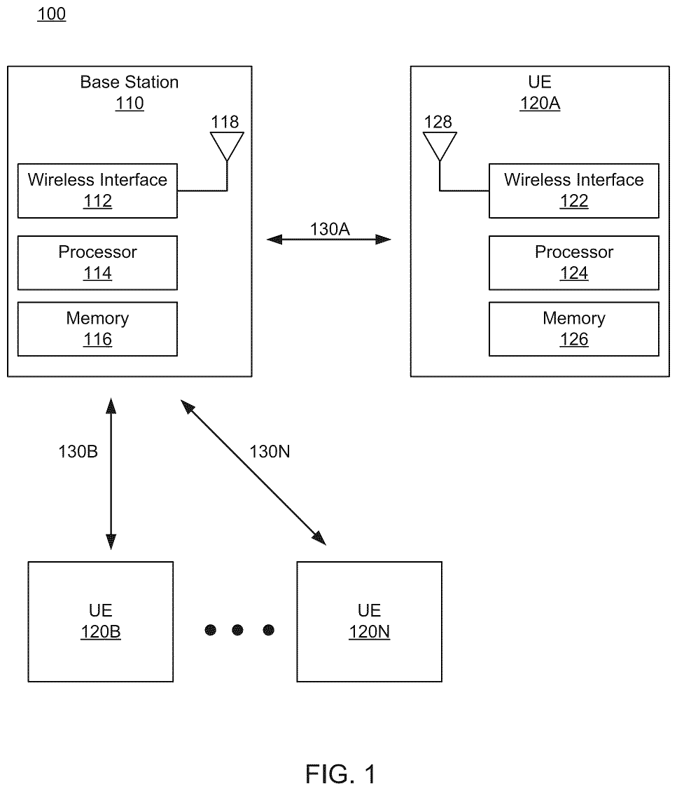

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130 (e.g., 130A, 130B, . . . 130N). The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110 and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through the wireless communication link 130 and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126 and execute the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency and encode or process the data. For example, the processor 124 may encode or process image data or audio data at the baseband frequency and provide the encoded or processed data to the wireless interface 122 for transmission.

The memory device 126 is a component that stores data. The memory device 126 may be embodied as random-access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

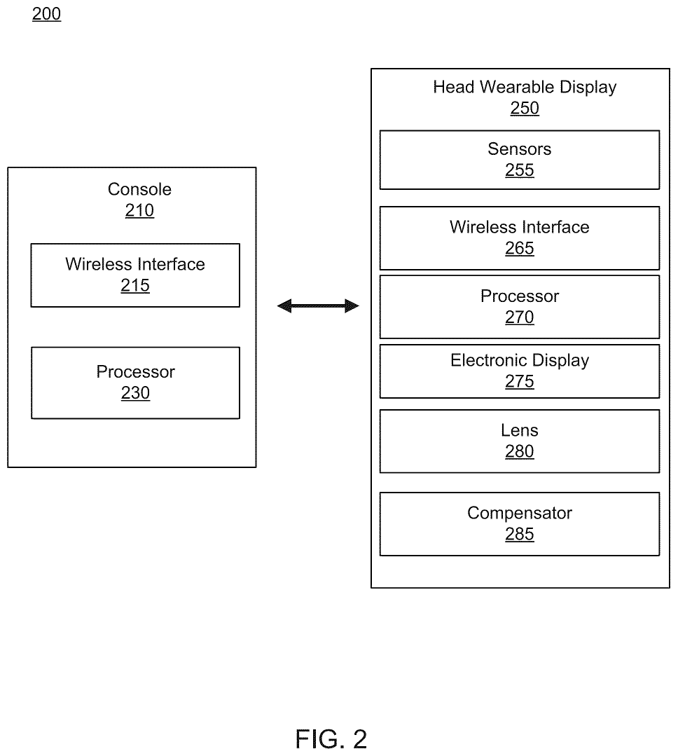

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gaze direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to the image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

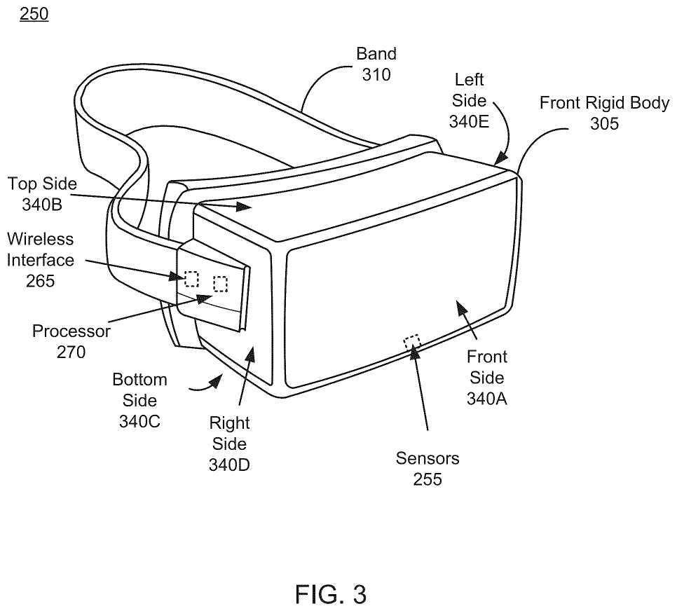

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

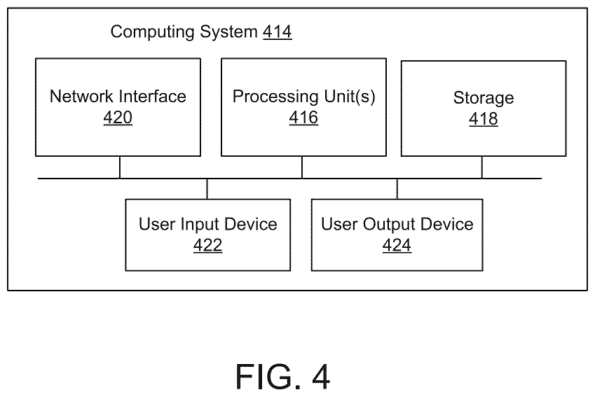

Various operations described herein can be implemented on computer systems. FIG. 4 shows a block diagram of a representative computing system 414 usable to implement the present disclosure. In some embodiments, the base station 110, the UEs 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414. The computing system 414 can interpret the signals as indicative of particular user requests or information. The user input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

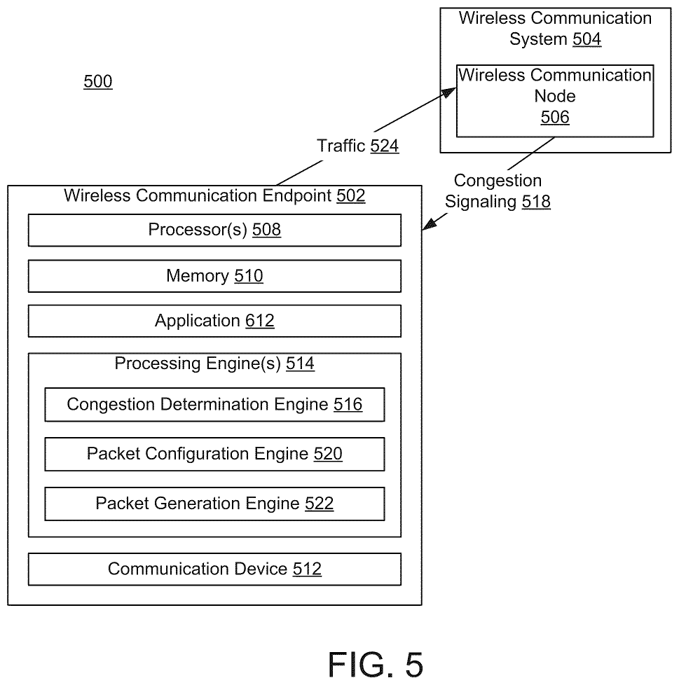

Referring generally to FIG. 5-FIG. 10, the present disclosure is directed to indicating congestion severity. For an AR/VR application, media codec bitrate adaptation at the application layer, and congestion control at the transport layer, can be employed to manage network flow/congestion to achieve a low latency transmission with a target quality-of-service (QoS) or quality of experience (QoE). An explicit congestion notification (ECN)/low latency low loss scalable throughput (LAS) approach can be an IP layer congestion/flow control mechanism which utilize two bits in an IP header to mark IP packets when a network node experiences a network congestion. However, the 2 bits may only tell whether network congested or not, without further information about congestion granularity. For a cellular network, a backhaul and core network can be designed with high capacity. Network congestion may mostly occur within a radio access network (RAN) or at the air interface between a user equipment (UE) and a base station (BS) due to limited radio resources. It can be beneficial for a cellular BS and a UE to coordinate and signal to an application to adapt a bitrate in an effective and timely manner.

The present solution addresses the above identified problems by utilizing an explicit congestion ECN/L4S marker, and/or reserved header bits in a PDCP layer to indicate network congestion severity. A bitrate optimizer may detect the explicit congestion signal (e.g., ECN/L4S) from an IP header, and may determine a severity of network congestion (e.g., low, medium, high). The bitrate optimizer may adjust (e.g., increase or decrease) a bitrate step size according to the severity of network congestion. A bitrate optimizer may detect the reserved header bits in the PDCP layer, and determine a severity of network congestion (e.g., level 1, level 2, level 3 . . . ). The bitrate optimizer may adjust (e.g., increase or decrease) a bitrate step size according to the severity of network congestion. Additionally, a UE may utilize an indication in a downlink (DL) to determine an uplink (UL) network congestion condition and to adjust a bitrate without waiting for receiver endpoint feedback, which may involve a duration of at least one round trip time (RTT).

Referring to FIG. 5, depicted is a block diagram of a system 500 for congestion severity signaling, according to an example implementation of the present disclosure. The system 500 may include a wireless communication endpoint 502 communicably coupled to a wireless communication system 504 including a wireless communication node 506. The wireless communication endpoint 502 may be similar to the user equipment 120, console 210, and/or HWD 250 described above with reference to FIG. 1-FIG. 4. In some embodiments, the wireless communication endpoint 502 may be an application server. In this regard, the wireless communication endpoint 502 can be or include user equipment and/or application servers, which generate and transmit uplink and/or downlink traffic to the wireless communication node 506. The wireless communication node 506 may be, include, or be similar to the base station 110 described above with reference to FIG. 1, or gNB 630 described below.

The wireless communication endpoint 502 may one or more processors 508, memory 510, and a communication device 512. While shown as included on the wireless communication endpoint 502, in various embodiments, the wireless communication system 504 (including the components/elements/wireless communication nodes 506 thereof) may similarly include processor(s), memory, and a communication device. The processor(s) 508 may be the same as or similar to the processors 114, 124, 230, 270 and/or processing unit(s) 416 described above with reference to FIG. 1-FIG. 4. The memory 510 may be the same as or similar to memory 116, 126, and/or storage 418 described above with reference to FIG. 1-FIG. 4. The communication device 512 may be the same as or similar to the wireless interface 112, 122, 215, 265 (e.g., in combination with or communicably coupled to antenna 118, 128) and/or network interface 420 described above with reference to FIG. 1-FIG. 4.

The wireless communication endpoint 502 may include one or more processing engines 514. The processing engine(s) 514 may be or include any device, component, element, or hardware designed or configured to perform one or more of the functions described herein. The processing engine(s) 514 may include a congestion determination engine 516, a packet configuration engine 520, and a packet generation engine 522. While these processing engine(s) 514 are shown and described herein, it should be understood that additional and/or alternative processing engine(s) 514 may be implemented on the wireless communication endpoint 502. Additionally, two or more of the processing engine(s) 514 may be implemented as a single processing engine 514. Furthermore, one of the processing engine(s) 514 may implemented as multiple processing engines 514.

As described in greater detail below, the congestion determination engine 516 may be configured to detect, determine, or otherwise identify a network congestion level, based on first packets received from the wireless communication node 506 and include bit(s) configured by the wireless communication node 506 according to a network congestion level (referred to generally as congestion signaling 518). The packet configuration engine 520 may be configured to selectively update configurations for generating subsequent traffic 524 (such as an updated bitrate,) according to the congestion signaling 518. The packet generation engine 522 may be configured to generate subsequent packet(s) (e.g., traffic 524) according to the determined/updated configurations.

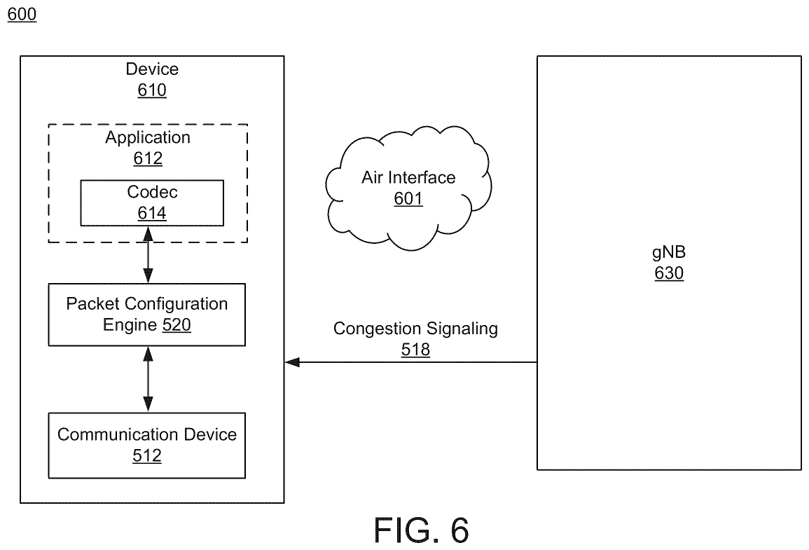

Referring now to FIG. 6, together with continued reference to FIG. 5, depicted is a block diagram of a system 600 for explicit congestion signaling, according to another example implementation of the present disclosure. As shown, the system 600 may include a device 610, which may be the same as/similar to the wireless communication endpoint 502 of FIG. 5. While described as a device 610, it should be understood that similar components, elements, hardware, etc. may be implemented at an application server (e.g., an application server). The device 610 is shown to include an application 612. The application 612 may be or include any type or form of application, such as but not limited to an extended reality (XR) application, a video call or conferencing application, an immersive application, a gaming application, or any other type/form of application which may use/support cellular communication. As shown in FIG. 6, the application 612 may include a codec 614. The device 610 may also include the packet configuration engine 520, and the communication device 512 (which may be implemented, defined, or otherwise provided at a layer of a network stack of the device, such as at the physical (PHY) layer or media access control (MAC) layer).

The device 610 may be communicably coupled to a Next Generation Node B (gNB) 630 via an air interface 601. The gNB 630 may be the same as/similar to the wireless communication node 506 described above with reference to FIG. 6. As shown in FIG. 6, the gNB 630 may be configured to transmit an explicit congestion signal 620 to the device 610 via the air interface 601. The explicit congestion signal 620 may be similar to the congestion signaling 518 shown in FIG. 5 and briefly introduced above. In some embodiments, the gNB 630 may select and scalably mark IP packets according to different levels of network load, among other conditions (e.g., queue size, traffic type, etc.), as described in greater detail below.

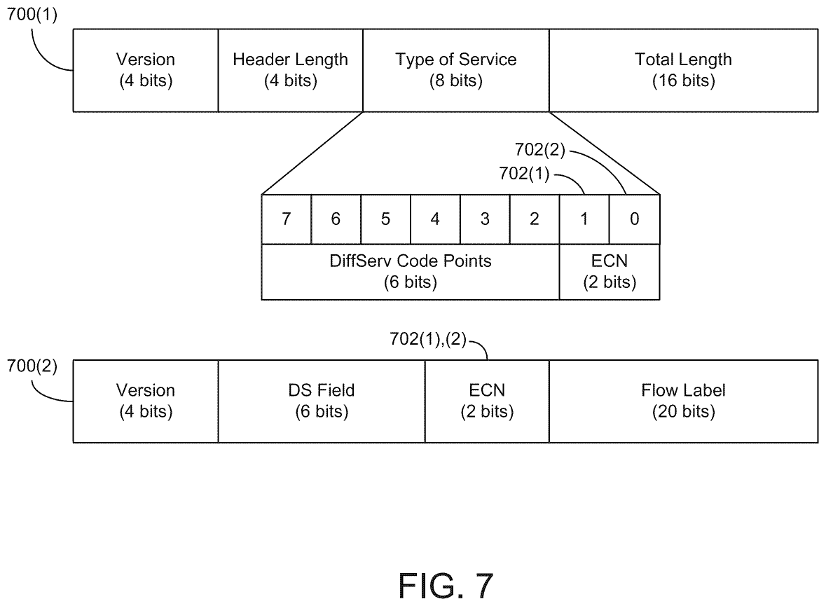

The packet configuration engine 520 may be configured to use the congestion signaling 518 from the gNB 630 to selectively update configurations of packets/traffic 524 generated by the application 612. That is, the packet configuration engine 520 may be configured to monitor the congestion signaling 518 (e.g., ECN/LAS from an IP packet header (e.g., IP headers 700(1), 700(2), as shown in FIG. 7). Then, the packet configuration engine 520 may be configured to adapt the bitrate based on the congestion signaling 518, such as a number of marked IP packets received and current conditions of a UE (e.g., buffer size, application latency sensitivity requirement, an RF condition, etc.). While described in the context of modifying/adapting/configuring a bitrate, it should be understood that other forms of adaptation/modifications may be applied to generation of subsequent packets, such as modifying a resolution (e.g., of video or graphics frames), or a frame rate (e.g., a frame refresh rate), to name a few non-limiting possibilities.

The codec 614 may include one or more encoders and decoders. The codec 614 may be configured to generate, configure, establish, derive, or otherwise encode (e.g., for the encoder, and correspondingly decode, for the decoder) data generated by the application 612 into a format for transmission to another endpoint. In some embodiments, the codec 614 may be or include a video codec used for encoding and decoding video data. For example, in the context of video data, the video encoder may be configured to apply compression to the video data of the application 612 (e.g., using a video codec, such as H.264, H.265, AV1, etc.), to generate encoded video packets. Similarly, the video decoder may be configured to decompress encoded video packets using a video decoder, for consumption/use thereby. While the example of video data is described herein, other types or forms of codecs may be used by the endpoints for reformatting/encoding/decoding other types of data. In some embodiments, the codec 614 may be implemented at the application layer of the endpoint 502 in connection with execution of the application 612 to encode/decode the data by the application.

The codec 614 may be configured to generate packets/PDUs/traffic according to a codec rate. The codec 614 may be configured to code input data, such as audio or video, into compressed packets or Protocol Data Units (PDUs) at a specified codec bitrate. The codec 614 may be configured to receive raw input data (e.g., from the application 612), such as audio samples or video frames, and compressing the raw input data based on the target codec rate. The codec rate may determine, define, set, or otherwise configure the amount of data generated by the codec 614 per second (e.g., balancing the quality of the encoded data with the bandwidth used for transmission). After compression, the codec 514 may segment the encoded data into packets suitable for transmission over the air interface 601 to the wireless communication node 506/gNB 630. The codec 614 may be configured to operate at a variable bitrate, which is set, determined, defined, or otherwise configured by the packet configuration engine 520.

In various embodiments, while described as adapting the bitrate, in various embodiments, the packet configuration engine 520 may be configured to modify configurations of other aspects of the packets generated by the codec 614. For example, the packet configuration engine 520 may be configured to modify a configuration corresponding to a resolution (which may be provided to the application 612 and used to generate raw data at different resolutions which is then encoded by the codec 614), and/or a frame rate (which may be provided to the application 612 and used to generate frames according to the frame rate, which are then encoded by the codec 614).

As described in greater detail below, the packet configuration engine 520 may be configured to determine to modify configuration(s) of the packet(s) generated by the application 612, based on or according to the congestion signaling 518 provided by the wireless communication node 506 and analyzed by the congestion determination engine 516. Various examples of congestion signaling 518 are described in greater detail below with reference to FIG. 7-FIG. 9.

Referring now to FIG. 7, depicted is a block diagram of an internet protocol (IP) packet frame having an explicit congestion notification (ECN) signaling field provided therein, according to an example implementation of the present disclosure. In various embodiments, the wireless communication node 506/gNB 630 may be configured to provide the congestion signaling 518 via ECN(s) signaling provided in packet(s) sent by the wireless communication node 506 to the wireless communication endpoint 502. More specifically, FIG. 7 depicts IP headers 700(1), 700(2) including ECN bits 702(1), 702(2), among other information (such as version bits, header length bits, DiffServ code points, total length, DS field bits, flow label bits, etc.). The ECN bits 702(1), 702(2) may be used to negotiate ECN between two or more wireless communication endpoints 502 (and wireless communication nodes 506 along the network path between the endpoints 502). For example, during negotiation and connection setup, a first wireless communication endpoint setting the ECN bits 702(1), 702(2) to “0 1” when the traffic is requested to be ECN-supported, set the ECN bits 702(1), 702(2) to “1 0” when traffic is requested to be low latency, low loss, and scalable throughput (L4S) supported. Along the network path, if one of the wireless communication nodes 506 do not support, e.g., ECN or L4S, the wireless communication node 506 may wipe the ECN bits (e.g., to “0 0” indicating that ECN/LAS is not supported, or wipe the ECN bits to “0 1” if LAS is not supported but ECN is supported).

Following connection set-up, as packets are exchanged by the endpoints 502 along the network path, where a particular wireless communication node 506 detects congestion at the wireless communication node 506 (e.g., due to buffer overload, excessive traffic, etc.), the wireless communication node 506 may be configured to set the ECN bits 702(1), 702(2) to “1 1” to indicate congestion is experienced at the wireless communication node 506. In some embodiments, the wireless communication node 506 may be configured to incorporate, include, or otherwise provide a pattern of ECN bits 702(1), 702(2), to indicate a severity or level of congestion experienced by the wireless communication node 506. In this regard, the wireless communication node 506 may be configured to signal the pattern to indicate the severity/level of congestion, as opposed to indicating that congestion is experienced in a binary manner (e.g., congestion experienced vs. congestion not experienced).

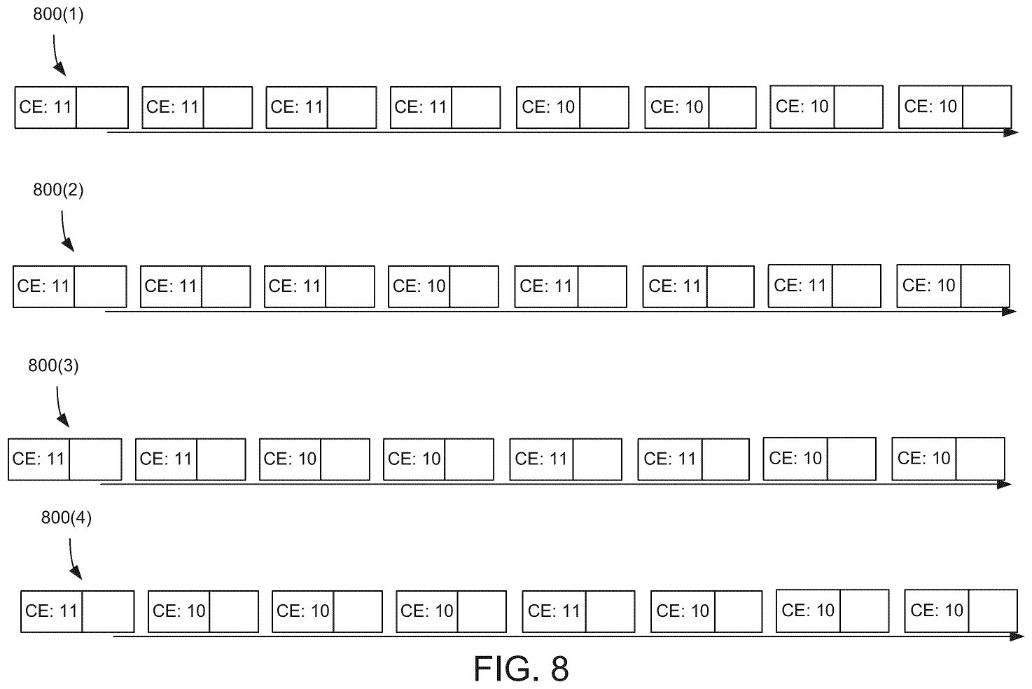

Referring now to FIG. 8, depicted are congestion patterns 800(1)-800(4) which provide congestion signaling 518 experienced by a wireless communication node 506, according to an example implementation of the present disclosure. For instance, FIG. 8 depicts four different congestion patterns 800(1)-800(4) which corresponds to different respective levels of congestion experienced by a wireless communication node 506. In the first congestion pattern 800(1), the wireless communication node 506 may mark four consecutive packets with congestion experienced (e.g., by setting the ECN bits 700(1), 700(2) to “1 1”), to indicate a first level of congestion (e.g., significant congestion beyond a first threshold). In the second congestion pattern 800(2), the wireless communication node 506 may mark three consecutive packets with congestion experienced, to indicate a second level of congestion (e.g., less than the first level). In the third congestion pattern 800(3), the wireless communication node may mark two consecutive packets with congestion experienced, to indicate a third level of congestion (e.g., less than the second level). In the fourth congestion pattern 800(4), the wireless communication node may mark alternating packets with congestion experienced, to indicate a fourth level of congestion (e.g., less than the third level). While these patterns and corresponding levels of congestion are described, it should be understood that other patterns may be used to provide additional levels of congestion.

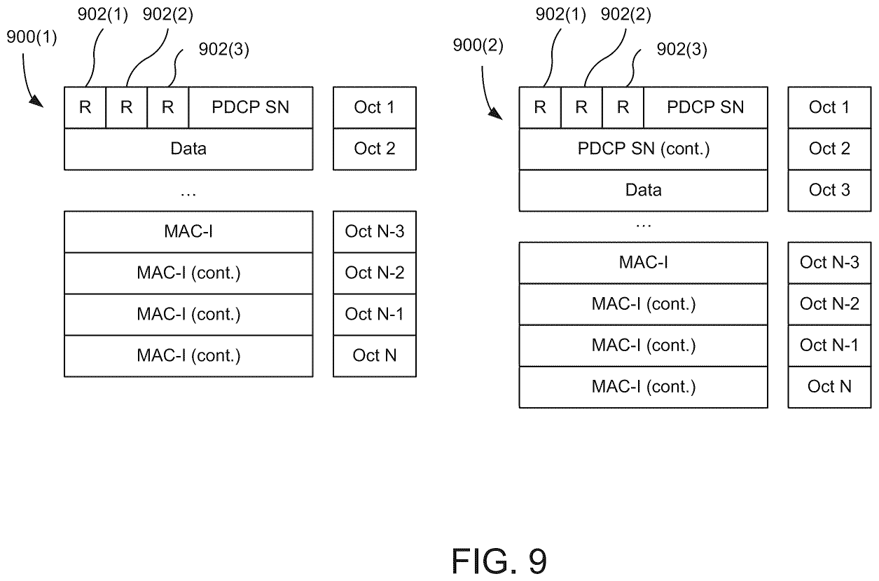

Referring now to FIG. 9, depicted are diagrams showing PDCP data headers used for congestion signaling 518 experienced by the wireless communication node 506, according to an example implementation of the present disclosure. More specifically, FIG. 9 depicts various examples of PDCP packets 900 which can include a header having, e.g., three reserved bits 902(1)-902(3), among other information. While three reserved bits 902 are provided in the PDCP packets 900, in various embodiments, the packets 900 may include additional/fewer reserved bits. The wireless communication node 506 may be configured to provide congestion signaling 518 indicating a level of congestion according to the values provided to the reserved bits 902(1)-902(3). In the example shown in FIG. 9, the wireless communication node 506 may be configured to signal the level of congestion experienced by the wireless communication node, from eight levels of congestion, according to values provided to the three reserved bits 902(1)-902(3) (e.g., no congestion experienced indicated by values of “0 0 0” for the reserved bits 902, significant congestion experienced by values of “1 1 1” for the reserved bits, and intermediate levels of congestion experienced by values between “0 00” and “1 1 1” for the reserved bits).

It should be understood that the granularity of levels indicated by the wireless communication node 506, either by way of a PDCP packet header reserved bits for one packet or by way of ECN marking patterns for a plurality of packets, may be defined according to, e.g., the number of defined patterns and/or the number of reserved bits.

Referring back to FIG. 5 and FIG. 6, the congestion determination engine 516 may be configured to determine the congestion level experienced by the wireless communication node 506, based on the congestion signaling 518 received in the one or more packet(s) from the wireless communication node 506. For example, where the congestion signaling 518 is included in a plurality of packets indicating a pattern corresponding to a particular level of congestion, the congestion determination engine 516 may be configured to determine the congestion level by tracking the ECN bits with values of “1 1” over the plurality of packets, to identify the pattern being signaled by the wireless communication node 506. The congestion determination engine 516 may be configured to determine the congestion level according to the identified pattern (e.g., by comparing the pattern signaled by the wireless communication node to one or more predefined patterns corresponding to respective congestion levels, and determining the congestion level which corresponds to the predefined pattern which matches the signaled pattern). Where the congestion signaling 518 is included in reserved bits of a PDCP layer packet header, the congestion determination engine 516 may be configured to determine the congestion level based on a defined correspondence between the values of the reserved bits and corresponding congestion levels.

The packet configuration engine 520 may be configured to selectively adapt, configure, or otherwise modify one or more configurations for the application 612 to generate subsequent packet(s), based on the congestion level signaled by the wireless communication node 506. Such configurations may include, for example, the codec bitrate (or more generally, the bitrate), a resolution of data generated by the application 612, and/or a refresh rate of such data. In some embodiments, the packet configuration engine 520 may be configured to modify the configuration(s) for generating the packet(s) in a stepwise function, according to the corresponding congestion levels. The stepwise function may be or include predetermined, predefined, or otherwise linked modifications to the configurations and corresponding congestion levels.

For example, where the congestion level indicates no congestion or relatively nominal congestion experienced by the wireless communication node 506, the packet configuration engine 520 may be configured to forego any modification of the configurations for generating subsequent packets. Where the congestion level indicates mild congestion experienced by the wireless communication node 506, the packet configuration engine 520 may be configured to reduce the bitrate by, e.g., 5%, reduce the resolution by one level (e.g., from 4K to 1440p), and/or reduce the refresh rate by 2 Hz. Where the congestion level indicates moderate congestion experienced by the wireless communication node 506, the packet configuration engine 520 may be configured to reduce the bitrate by, e.g., 15%, reduce the resolution by two levels (e.g., from 4K to 1080p), and/or reduce the refresh rate by 5 Hz. Where the congestion level indicates significant congestion experienced by the wireless communication node 506, the packet configuration engine 520 may be configured to reduce the bitrate by, e.g., 30%, reduce the resolution to a third (or a lowest acceptable) level (e.g., from 4K to 720p), and/or reduce the refresh rate to a minimum frequency (e.g., from 60 Hz to 45 Hz). In this regard, the packet configuration engine 520 may be configured to dynamically adapt configurations for generating packet(s) based on levels of congestion experienced by the wireless communication node 506, as opposed to adapting configurations based on binary congestion experienced signaling by wireless communication nodes 506.

The packet generation engine 522 may be configured to generate, produce, or otherwise provide one or more subsequent packet(s) configured by the application 612 according to the configurations determined/configured by the packet configuration engine 520. In some embodiments, the packet generation engine 522 may be configured to provide signaling to the application 612 and/or codec 614 to control generation of the packet(s), according to the configurations determined by the packet configuration engine 520. For example, and in some embodiments, where the packet configuration engine 520 determines a different codec rate is to be used for generating the subsequent packet(s), the packet generation engine 522 may be configured to transmit, signal, message, or otherwise provide the codec rate to the codec 614 for implementation thereby. As another example, where the packet configuration engine 520 determines a different refresh rate and/or a different resolution for generating, e.g., video frames, the packet generation engine 522 may be configured to transmit, signal, message, or otherwise provide the refresh rate/resolution to the application 612, for the application 612 to generate subsequent video frames according to the updated refresh rate/resolution. In these examples, the application 612 and/or codec 614 may be configured to generate the subsequent packet(s) according to the configuration(s) received via the packet generation engine 522 from the packet configuration engine 520. The application 612 and/or codec 614 may be configured to provide the subsequent packet(s) to the communication device 512, for transmission to the wireless communication node 506 (e.g., as traffic 524).

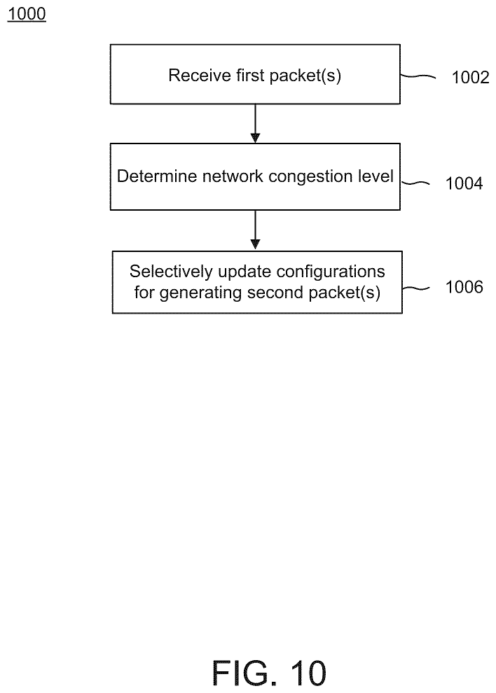

Referring now to FIG. 10, depicted is a flowchart showing an example method 1000 for explicit congestion signaling, according to an example implementation of the present disclosure. The method 1000 may be performed by the devices, components, elements, or hardware described above with reference to FIG. 1-FIG. 9. As a brief overview, at step 1002, a wireless communication endpoint may receive first packets from a base station. At step 1004, the wireless communication endpoint may determine a network congestion level. At step 1106, the wireless communication endpoint may selectively update configurations for generating second packets.

At step 1002, a wireless communication endpoint may receive one or more packets from a base station. In some embodiments, the wireless communication endpoint includes at least one of an application server or user equipment, as described above. The wireless communication endpoint may receive the packet(s), responsive to a different endpoint (e.g., in communication with the wireless communication endpoint) generating and transmitting the packets via a wireless communication network (e.g., network nodes including the base station) to the wireless communication endpoint. Such packet(s) may be or include, for example, internet protocol (IP) packets, protocol data units (PDUs), or other traffic carrying data relating to an application used by the endpoints.

The one or more first packets may include one or more bits configured by the base station based according to a network congestion level. In some embodiments, the one or more packets may include a plurality of packets. For example, each IP packet of the plurality of packets may include a field corresponding to an explicit congestion notification signal from the base station. The base station may configure values of the field to indicate a respective network congestion level (e.g., to form a pattern corresponding to the values of the field across successive packets of the plurality of packets). In some embodiments, the packet(s) may include a header having two or more bits. More specially, the two or more bits may be included in a packet data convergence protocol (PDCP) layer header. For example, the header may include reserved bits. The base station may configure the values for the two or more bits (e.g., the reserved bits) to indicate or otherwise identify a respective network congestion level.

At step 1004, the wireless communication endpoint may determine the network congestion level from a plurality of network congestion levels. The wireless communication endpoint may determine the network congestion level based on the one or more bits configured by the base station in the one or more packets. In instances where the one or more packets include the plurality of first packets, the wireless communication endpoint may be configured to determine the network congestion level at step 1004 based on a first count of first values of the field, for a portion of the plurality of first packets, relative to a second count of second values of the field, for another portion of the plurality of first packets. For instance, the wireless communication endpoint may determine the network congestion level based on a pattern of values indicated in the field corresponding to the explicit congestion notification signal. For example, and as described above with reference to FIG. 8, the wireless communication endpoint may determine the network congestion level based on the pattern of values signaled in successive packets by the wireless communication node (e.g., which may include one or more of the patterns shown in FIG. 8). As another example, where the header of the one or more first packets includes the at least three bits, a respective value of the at least three bits may be configurable by the base station to indicate a respective network congestion level from eight different network congestion levels. In this example, the wireless communication endpoint may determine the network congestion level using the value of the bits configured by the base station, which signals or otherwise corresponds to the determined network congestion level.

At step 1006, the wireless communication endpoint may selectively update one or more configurations for generating one or more second packets for transmission to the base station. The wireless communication endpoint may selectively update the configuration(s) according to the network congestion level determined at step 1004. The wireless communication endpoint may selectively update the configuration(s), for generating subsequent packet(s), based on the level of network congestion determined at step 1004 relating to previously-received packet(s). In some embodiments, the one or more configurations selectively updated at step 1006 may include at least one of a bitrate, a resolution, or a frame rate. The wireless communication endpoint may selectively update the configurations, by providing signaling to a codec and/or an application of the wireless communication endpoint, to cause the application/codec to generate the subsequent packet(s) according to the updated configurations.

According to various embodiments in which the one or more configurations include the bitrate, the wireless communication endpoint may provide signaling/a message to the codec of the application, to cause the codec to encode data of the application according to the updated bitrate. According to various embodiments in which the one or more configurations include the resolution, the wireless communication endpoint may provide signaling/a message to the application, to cause the application to generate data (e.g., video frames) at the resolution signaled by the wireless communication node. According to various embodiments in which the one or more configurations include the refresh rate, the wireless communication endpoint may provide signaling/a message to the application, to cause the application to generate frames (e.g., video frames) at a rate corresponding to the refresh rate.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’”' can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by a wireless communication endpoint from a base station, one or more first internet protocol packets, including one or more bits configured by the base station based according to a network congestion level;
determining, by the wireless communication endpoint, the network congestion level from a plurality of network congestion levels, based on the one or more bits configured by the base station in the one or more first packets; and
selectively updating, by the wireless communication endpoint, one or more configurations for generating one or more second packets for transmission to the base station, according to the network congestion level.

2. The method of claim 1, wherein the one or more configurations comprise a bitrate, the method further comprising:
determining, by the wireless communication endpoint, to update the bitrate for generating the one or more second packets, based on the network congestion level; and
generating, via a codec of the wireless communication endpoint, the one or more second packets using the updated bitrate.

3. The method of claim 2, further comprising:
transmitting, by the wireless communication endpoint to the base station, the one or more second packets generated using the updated bitrate.

4. The method of claim 1, wherein the one or more configurations comprise at least one of a bitrate, a resolution, or a frame rate.

5. The method of claim 1, wherein the one or more first packets comprise a plurality of first packets, each packet of the plurality of first packets having a field corresponding to an explicit congestion notification signal from the base station.

6. The method of claim 5, wherein the wireless communication endpoint determines the network congestion level based on a first count of first values of the field, for a portion of the plurality of first packets, relative to a second count of second values of the field, for another portion of the plurality of first packets.

7. The method of claim 6, wherein the wireless communication endpoint determines the network congestion level based on a pattern of values indicated in the field corresponding to the explicit congestion notification signal.

8. The method of claim 1, wherein the one or more first packets include a header having two or more bits, wherein a value of the two or more bits corresponds to a respective network congestion level.

9. The method of claim 8, wherein the header has at least three bits corresponding to the respective network level, wherein a respective value of the at least three bit is configurable by the base station to indicate a corresponding network congestion level from eight different network congestion levels.

10. The method of claim 8, wherein the two or more bits are included in a packet data convergence protocol (PDCP) layer header.

11. The method of claim 1, wherein the wireless communication endpoint comprises at least one of an application server or user equipment.

12. A wireless communication endpoint, comprising:
a transceiver; and
one or more processors configured to:
receive, via the transceiver from a base station, one or more first packets, including one or more bits configured by the base station based according to a network congestion level;
determine the network congestion level from a plurality of network congestion levels, based on the one or more bits configured by the base station in the one or more first packets; and
selectively update one or more configurations for generating one or more second packets for transmission to the base station, according to the network congestion level.

13. The wireless communication endpoint of claim 12, wherein the one or more configurations comprise a bitrate, wherein the one or more processors are further configured to:
determine to update the bitrate for generating the one or more second packets, based on the network congestion level;
generate, via a codec, the one or more second packets using the updated bitrate; and
transmit, via the transceiver, the one or more second packets to the base station.

14. The wireless communication endpoint of claim 12, wherein the one or more configurations comprise at least one of a bitrate, a resolution, or a frame rate.

15. The wireless communication endpoint of claim 12, wherein the one or more first packets comprise a plurality of first packets, each IP packet of the plurality of first packets having a field corresponding to an explicit congestion notification signal from the base station.

16. The wireless communication endpoint of claim 15, wherein the one or more processors are configured to determine the network congestion level based on a pattern of values indicated in the field corresponding to the explicit congestion notification signal.

17. The wireless communication endpoint of claim 12, wherein the one or more first packets include a header having two or more bits, wherein a value of the two or more bits corresponds to a respective network congestion level.

18. The wireless communication endpoint of claim 17, wherein the header has at least three bits corresponding to the respective network level, wherein a respective value of the at least three bit is configurable by the base station to indicate a corresponding network congestion level from eight different network congestion levels.

19. The wireless communication endpoint of claim 12, wherein the wireless communication endpoint comprises at least one of an application server or user equipment.

20. A non-transitory computer readable medium storing instructions that, when executed by one or more processors, cause the one or more processors to:
receive, from a base station, one or more first packets, the one or more first packets including one or more bits configured by the base station based according to a network congestion level;
determine the network congestion level from a plurality of network congestion levels, based on the one or more bits configured by the base station in the one or more first packets; and
selectively update one or more configurations for generating one or more second packets for transmission to the base station, according to the network congestion level.
